(19) United States
(12) Patent Application Publication
(10) Pub. No.: US 2024/0389199 A1
(43) Pub. Date: Nov. 21, 2024

(54) PTC HEATER WITH IMPROVED TEMPERATURE DISTRIBUTION AND UNIFORMITY

(71) Applicant: Littelfuse, Inc., Chicago, IL (US)

(72) Inventors: Jun Gang Wang, Chicago, IL (US); Yu Tian, Shanghai (CN); ChiHao Ku, New Taipei City (TW); Sky Chen, Chicago, IL (US)

(73) Assignee: Littelfuse, Inc., Chicago, IL (US)

(21) Appl. No.: 18/655,587

(22) Filed: May 6, 2024

(30) Foreign Application Priority Data
May 15, 2023 (CN) 2023105471715

(51) Int. Cl. H05B 3/14; H05B 3/03

(52) U.S. Cl. CPC H05B 3/146; H05B 3/03; H05B 2203/006; H05B 2203/02

(57) ABSTRACT

A positive temperature coefficient (PTC) heater including a PTC layer formed of a material exhibiting a non-linear change in resistance in response to changes in temperature, an electrode layer including first and second electrodes disposed atop the PTC layer, each of the first and second electrodes including a spine and a plurality of tines extending inwardly therefrom, with the spine of the first electrode oriented parallel to the spine of the second electrode and with the tines of the first electrode disposed in an interdigitated relationship with the tines of the second electrode, an adhesive layer including first and second adhesive strips disposed atop the spines of the first and second electrodes, respectively, and a busbar layer including first and second busbars disposed atop the first and second adhesive strips, respectively, and adhered to the spines of the first and second electrodes by the first and second adhesive strips, respectively.

### CROSS-REFERENCE TO RELATED APPLICATION

This application claims priority to Chinese Patent Application serial number 2023105471715, filed May 15, 2023, entitled “PTC HEATER WITH IMPROVED TEMPERATURE DISTRIBUTION AND UNIFORMITY,” which is incorporated by reference herein in its entirety.

### FIELD OF THE DISCLOSURE

The present disclosure relates generally to the field of heating devices and relates more particularly to a multilayer positive temperature coefficient heating device that provides uniform heating over a relatively large area.

### FIELD OF THE DISCLOSURE

A positive temperature coefficient (PTC) material is a material that exhibits a positive temperature coefficient, meaning that as its temperature increases its resistance increases proportionately. Typically, current can be passed through devices composed of a PTC material until the temperature of the material reaches a specific “trip temperature,” at which point the resistance of the material rapidly rises, effectively arresting the flow of current through the material.

A polymeric PTC (pPTC) material is a PTC material composed of a non-conductive crystalline polymer infused with carbon particles. When such a material is operating below its trip temperature, the polymer is in a crystalline state with the carbon particles forming conductive paths through the polymer. If excessive current is passed through the material, the material will heat and the polymer will change to an amorphous state, thereby separating the carbon particles and breaking the current paths. Once the material is cooled, the polymer will return to a crystalline state, thereby reestablishing the current paths created by the carbon particles.

pPTC material is well-known for its use in resettable fuses. In such fuses, pPTC material will prevent the flow of current once a fuse has reached its trip temperature and will subsequently allow current to flow again after the fuse is cooled to a temperature below the trip temperature. Resettable fuses that incorporate pPTC materials are well-known in the art.

Another common use for pPTC materials is in heating devices. Heating devices that implement pPTC materials provide advantages over resistive heaters in which current is passed through a metal wire in that, because of the properties of pPTC materials, pPTC heaters are self-limiting and cannot overheat. Further, PTC heating elements have a high-power density and, as such, are very efficient at heat production, even within small spaces.

Despite providing numerous advantages, pPTC heaters are associated with certain shortcomings. For example, pPTC heaters often exhibit nonuniform heat dispersion, creating undesirable hot spots and cold spots. Additionally, heat generated by a pPTC heater is often concentrated in a relatively small area of the heater, resulting in an effective heating area that is significantly smaller than the overall size of the heater. It is with respect to these and other considerations that the present improvements may be useful.

### SUMMARY

This Summary is provided to introduce a selection of concepts in a simplified form further described below in the Detailed Description. This Summary is not intended to identify key features or essential features of the claimed subject matter, nor is the summary intended as an aid in determining the scope of the claimed subject matter.

A positive temperature coefficient (PTC) heater in accordance with an embodiment of the present disclosure includes a PTC layer formed of a material that exhibits a non-linear change in resistance in response to changes in temperature, an electrode layer including first and second electrodes disposed atop the PTC layer, each of the first and second electrodes including an elongated spine and a plurality of tines extending inwardly therefrom, with the spine of the first electrode oriented parallel to the spine of the second electrode and with the tines of the first electrode disposed in an interdigitated, spaced-apart relationship with the tines of the second electrode, an adhesive layer including first and second adhesive strips disposed atop the spines of the first and second electrodes, respectively, and a busbar layer including first and second busbars disposed atop the first and second adhesive strips, respectively, and adhered to the spines of the first and second electrodes by the first and second adhesive strips, respectively.

A method of manufacturing a positive temperature coefficient (PTC) heater in accordance with an embodiment of the present disclosure includes providing a PTC layer formed of a material that exhibits a non-linear change in resistance in response to changes in temperature, disposing an electrode layer including first and second electrodes atop the PTC layer, each of the first and second electrodes including an elongated spine and a plurality of tines extending inwardly therefrom, with the spine of the first electrode oriented parallel to the spine of the second electrode and with the tines of the first electrode disposed in an interdigitated, spaced-apart relationship with the tines of the second electrode, disposing an adhesive layer including first and second adhesive strips atop the spines of the first and second electrodes, respectively, and disposing a busbar layer including first and second busbars atop the first and second adhesive strips, respectively, whereby the first and second busbars are adhered to the spines of the first and second electrodes, respectively.

### BRIEF DESCRIPTION OF THE DRAWINGS

FIG. 1 is a perspective view illustrating a PTC heater in accordance with an embodiment of the present disclosure;

FIG. 2 is an exploded view of the PTC heater shown in FIG. 1;

FIG. 3 is flow diagram illustrating an embodiment of a method for manufacturing the PTC heater shown in FIG. 1 in accordance with an embodiment of the present disclosure.

### DETAILED DESCRIPTION

Embodiments of a positive temperature coefficient (PTC) heater and a method for manufacturing the same in accordance with the present disclosure will now be described more fully with reference to the accompanying drawings, in which preferred embodiments of the present disclosure are presented. The PTC heater and the accompanying method of the present disclosure may, however, be embodied in many different forms and should not be construed as being limited to the embodiments set forth herein. Rather, these embodiments are provided so that this disclosure will be thorough and complete, and will fully convey the scope of the PTC heater and the accompanying method to those skilled in the art. In the drawings, like numbers refer to like elements throughout unless otherwise noted.

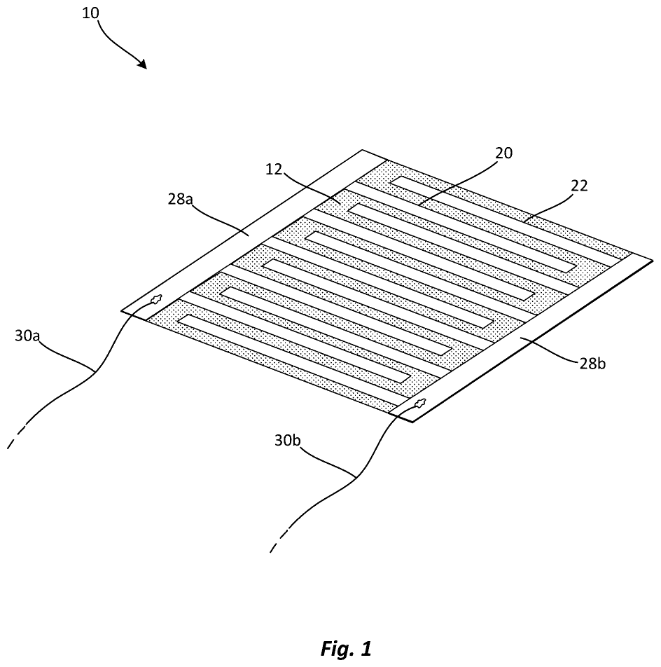

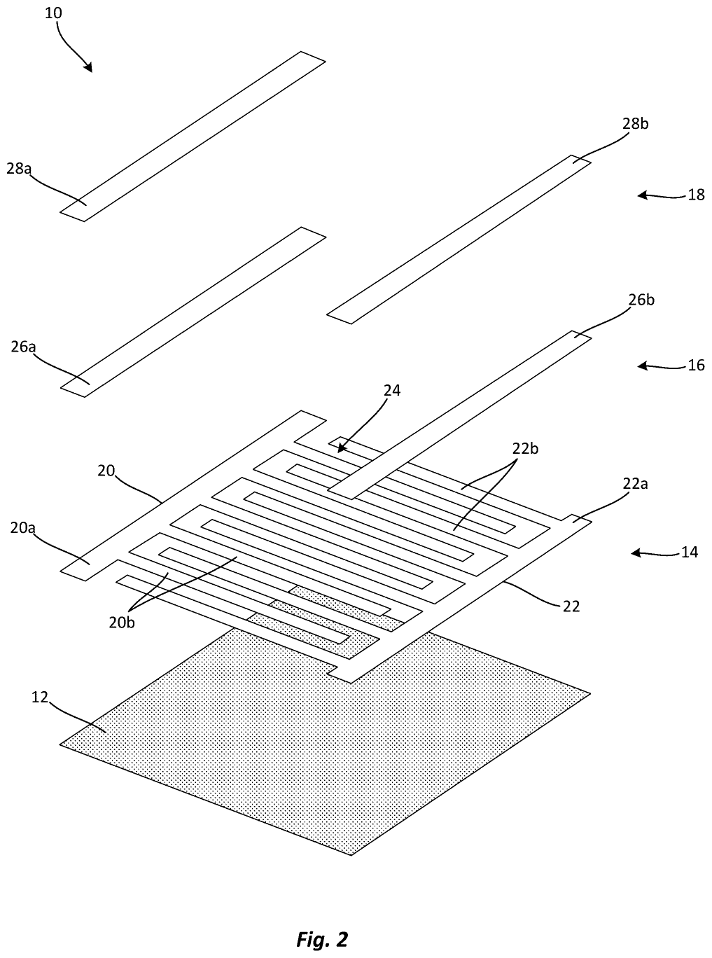

Referring to FIGS. 1 and 2, a perspective view and an exploded view illustrating a PTC heater 10 (hereinafter “the heater 10”) in accordance with an exemplary embodiment of the present disclosure are shown, respectively. For the sake of convenience and clarity, terms such as “top,” “bottom,” “above,” “below,” “lateral,” “longitudinal,” “vertical,” “horizontal,” etc. may be used herein to describe the relative placement and orientation of various components of the heater 10, each with respect to the geometry and orientation of the heater 10 as it appears in FIGS. 1 and 2. Said terminology will include the words specifically mentioned, derivatives thereof, and words of similar import.

The heater 10 may be a laminate structure formed of a plurality of layers, including a PTC layer 12, an electrode layer 14, an adhesive layer 16, and a busbar layer 18 arranged in a vertically stacked configuration in the aforementioned order. The PTC layer 12 may be a planar sheet formed of a material that exhibits non-linear changes in resistance in response to changes in temperature. For example, the PTC layer 12 may be formed of a polymeric positive temperature coefficient (pPTC) conductive composition that includes a polymer and a conductive filler. In various embodiments, the polymer of the pPTC material may be a crystalline polymer such as polyethylene, polypropylene, polyoctylene, polyvinylidene chloride, and mixtures thereof, or a semi-crystalline polymer such as polyvinylidene difluoride, polyethylene, ethylene tetrafluoroethylene, ethylene-vinyl acetate, ethylene butyl acrylate, different materials having similar characteristics, and mixtures thereof. The conductive filler may be dispersed in the polymer and may be selected from a group that includes, but is not limited to, carbon black, metal powder, conductive ceramic powder, and mixtures thereof. Furthermore, to improve the sensitivity and physical properties of the PTC layer 12, the pPTC material may include various additives, such as a photo initiator, a cross-link agent, a coupling agent, a dispersing agent, a stabilizer, an antioxidant, and/or a nonconductive anti-arcing filler. In some embodiments, the PTC layer 12 may be applied as a layer of pPTC ink and subsequently cured. The present disclosure is not limited in this regard.

The electrode layer 14 may include generally planar first and second electrodes 20, 22 disposed atop the PTC layer 12. Each of the first and second electrodes 20, 22 may include a longitudinally elongated spine 20a, 22a (i.e., elongated in a direction parallel to the Z-axis of the illustrated Cartesian coordinate system) and a plurality tines 20b, 22b that extend laterally inwardly from the spines 20a, 22a, respectively (i.e., extend perpendicularly from the spines 20a, 22a in a direction parallel to the X-axis of the illustrated Cartesian coordinate system). The tines 20b of the first electrode 20 may be disposed in an interdigitated, spaced-apart relationship with the tines 22b of the second electrode 22 to define a serpentine gap 24 therebetween. The first and second electrodes 20, 22 may be formed of any suitable electrically conductive material, including, but not limited to, copper, silver, tin, gold, etc.

The adhesive layer 16 may include longitudinally extending first and second adhesive strips 26a, 26b that may be disposed atop, and that may generally cover, the spines 20a, 22a of the first and second electrodes 20, 22. The first and second adhesive strips 26a, 26b may be formed of an electrically conductive adhesive, such as an electrically conductive glue or epoxy. In various embodiments, the first and second adhesive strips 26a, 26b may be applied to the top surfaces of the spines 20a, 22a and subsequently allowed to dry or cure. The present disclosure is not limited in this regard.

The busbar layer 18 may include longitudinally extending first and second busbars 28a, 28b that may be disposed atop the first and second adhesive strips 26a, 26b, and that may be adhered to the spines 20a, 22a of the first and second electrodes 20, 22 by the first and second adhesive strips 26a, 26b, respectively. Each of the first and second busbars 28a, 28b may have a length and width that is substantially equal to the length and width of the spines 20a, 22a, and may thus substantially cover the spines 20a, 22a, respectively. The first and second busbars 28a, 28b may be formed an electrically conductive metallic foil. In various embodiments, the metallic foil may be formed of copper, silver, gold, or the like. The present disclosure is not limited in this regard.

Referring to FIG. 1, electrically conductive first and second leads 30a, 30b may be connected to the first and second busbars 28a, 28b (e.g., via solder) for connecting the heater 10 within a circuit. During operation of the heater 10, electrical current may flow between the first and second leads 30a, 30b, through the heater 10, thereby causing the temperature of the PTC layer 12 to increase, thus heating a device or structure to which the heater 10 is mounted. For example, electrical current may flow from the first lead 30a, through the first busbar 28a, through the first adhesive strip 26a, through the first electrode 20, through the PTC layer 12 (across the gap 24), through the second electrode 22, through the second adhesive strip 26b, through the first busbar 28b, and may exit through the second lead 30b. The electrical resistance of the PTC layer 12 may increase as the temperature of the PTC layer 12 increases. If the temperature of the PTC layer 12 exceeds a predetermined trip temperature (e.g., in response to an overcurrent condition in the heater 10), the PTC layer 12 may effectively arrest the flow of current through the heater 10, thereby preventing the PTC layer 12 from overheating. The heater 10 is therefore “self-limiting.” When the PTC layer 12 cools to a temperature below the trip temperature, the PTC layer 12 may once again become electrically conductive and the heater 10 may function as normal.

Owning to the presence of the first and second busbars 28a, 28b and the first and second adhesive strips 26a, 26b between the first and second leads 30a, 30b and the first and second electrodes 20, 22, respectively, electrical power applied to the heater 10 via the first and second leads 30a, 30b may be relatively evenly distributed throughout the first and second electrodes 20, 22. That is, voltage drops between the tines 18a of the first electrode 20 and adjacent tines 18b of the second electrode 22 may be generally uniform, resulting in generally uniform heating of the PTC layer 12 along its entire length and across its entire width. Thus, heating provided by the heater 10 may be more uniformly distributed, and may be distributed over a larger area, relative to prior art PTC heating devices in which heating may tend to be concentrated in relatively small area of a device.

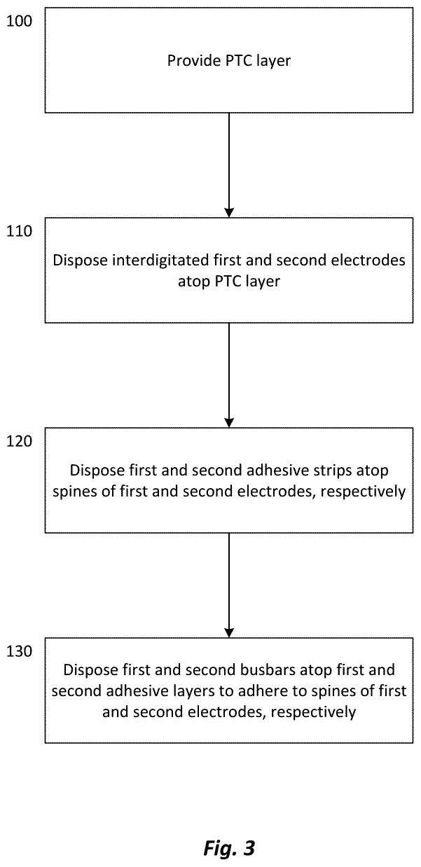

Referring to FIG. 3, a flow diagram illustrating an exemplary method for manufacturing the above-described heater 10 in accordance with the present disclosure is shown. The method will now be described in conjunction with the illustrations of the heater 10 shown in FIGS. 1 and 2.

At block 100 of the exemplary method, the PTC layer 12 may be provided. In various embodiments, the PTC layer 12 may be formed of pPTC conductive composition that includes a polymer and a conductive filler. In various embodiments, the polymer of the pPTC material may be a crystalline polymer such as polyethylene, polypropylene, polyoctylene, polyvinylidene chloride, and mixtures thereof, or a semi-crystalline polymer such as polyvinylidene difluoride, polyethylene, ethylene tetrafluoroethylene, ethylene-vinyl acetate, ethylene butyl acrylate, different materials having similar characteristics, and mixtures thereof. The conductive filler may be dispersed in the polymer and may be selected from a group that includes, but is not limited to, carbon black, metal powder, conductive ceramic powder, and mixtures thereof. Furthermore, to improve the sensitivity and physical properties of the PTC layer 12, the pPTC material may include various additives, such as a photo initiator, a cross-link agent, a coupling agent, a dispersing agent, a stabilizer, an antioxidant, and/or a nonconductive anti-arcing filler. In some embodiments, the PTC layer 12 may be applied as a layer of pPTC ink and subsequently cured. The present disclosure is not limited in this regard.

At block 110 of the exemplary method, the electrode layer 14 may be disposed atop the PTC layer 12, with the longitudinally extending spines 20a, 22a of the first and second electrodes 20, 22 disposed on the lateral edges of the PTC layer 12 and with the laterally extending tines 20b, 22b of the first and second electrodes 20, 22 disposed in an interdigitated, spaced-apart relationship to define the serpentine gap 24 therebetween. The first and second electrodes 20, 22 may be formed of any suitable electrically conductive material, including, but not limited to, copper, silver, tin, gold, etc.

At block 120 of the exemplary method, the first and second adhesive strips 26a, 26b of the adhesive layer 16 may be disposed atop, and may generally cover, the spines 20a, 22a of the first and second electrodes 20, 22. The first and second adhesive strips 26a, 26b may be formed of an electrically conductive adhesive, such as an electrically conductive glue or epoxy. In various embodiments, the first and second adhesive strips 26a, 26b may be applied to the top surfaces of the spines 20a, 22a and subsequently allowed to dry or cure. The present disclosure is not limited in this regard.

At block 130 of the exemplary method, the first and second busbars 28a, 28b of the busbar layer 18 may be disposed atop the first and second adhesive strips 26a, 26b (prior to drying/curing of the first and second adhesive strips 26a, 26b), and may thereby be adhered to the spines 20a, 22a of the first and second electrodes 20, 22. Each of the first and second busbars 28a, 28b may have a length and width that is substantially equal to the length and width of the spines 20a, 22a, and may thus substantially cover the spines 20a, 22a, respectively. The first and second busbars 28a, 28b may be formed an electrically conductive metallic foil. In various embodiments, the metallic foil may be formed of copper, silver, gold, or the like. The present disclosure is not limited in this regard.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

While the present disclosure makes reference to certain embodiments, numerous modifications, alterations and changes to the described embodiments are possible without departing from the sphere and scope of the present disclosure, as defined in the appended claim(s). Accordingly, it is intended that the present disclosure not be limited to the described embodiments, but that it has the full scope defined by the language of the following claims, and equivalents thereof.

1. A positive temperature coefficient (PTC) heater comprising:
a PTC layer formed of a material that exhibits a non-linear change in resistance in response to changes in temperature;
an electrode layer comprising first and second electrodes disposed atop the PTC layer, each of the first and second electrodes including an elongated spine and a plurality of tines extending inwardly therefrom, with the spine of the first electrode oriented parallel to the spine of the second electrode and with the plurality of tines of the first electrode disposed in an interdigitated, spaced-apart relationship with the plurality of tines of the second electrode;
an adhesive layer comprising first and second adhesive strips disposed atop the spines of the first and second electrodes, respectively; and
a busbar layer comprising first and second busbars disposed atop the first and second adhesive strips, respectively, and adhered to the spines of the first and second electrodes by the first and second adhesive strips, respectively.

2. The PTC heater of claim 1, wherein the PTC layer is formed of a polymeric PTC conductive composition.

3. The PTC heater of claim 2, wherein the polymeric PTC conductive composition comprises a polymer and a conductive filler.

4. The PTC heater of claim 3, wherein the polymer is a crystalline polymer selected from a group consisting of polypropylene, polyoctylene, polyvinylidene chloride, and mixtures thereof, or a semi-crystalline polymer such as polyvinylidene difluoride, polyethylene, ethylene tetrafluoroethylene, ethylene-vinyl acetate, ethylene butyl acrylate, and mixtures thereof.

5. The PTC heater of claim 3, wherein the conductive filler is selected from a group consisting of carbon black, metal powder, conductive ceramic powder, and mixtures thereof.

6. The PTC heater of claim 3, wherein the polymeric PTC conductive composition further comprises at least one of a photo initiator, a cross-link agent, a coupling agent, a dispersing agent, a stabilizer, an antioxidant, and a nonconductive anti-arcing filler.

7. The PTC heater of claim 1, wherein the first and second electrode are formed of one of copper, silver, tin, and gold.

8. The PTC heater of claim 1, wherein the first and second adhesive strips are formed of one of conductive glue and conductive epoxy.

9. The PTC heater of claim 1, wherein the first and second busbars are formed of an electrically conductive metal foil.

10. The PTC heater of claim 9, wherein the electrically conductive metal foil is formed of one of copper, gold, and silver.

11. A method of manufacturing a positive temperature coefficient (PTC) heater, the method comprising:
providing a PTC layer formed of a material that exhibits a non-linear change in resistance in response to changes in temperature;
disposing an electrode layer comprising first and second electrodes atop the PTC layer, each of the first and second electrodes including an elongated spine and a plurality of tines extending inwardly therefrom, with the spine of the first electrode oriented parallel to the spine of the second electrode and with the plurality of tines of the first electrode disposed in an interdigitated, spaced-apart relationship with the plurality of tines of the second electrode;
disposing an adhesive layer comprising first and second adhesive strips atop the spines of the first and second electrodes, respectively; and
disposing a busbar layer comprising first and second busbars atop the first and second adhesive strips, respectively, whereby the first and second busbars are adhered to the spines of the first and second electrodes, respectively.

12. The method of claim 11, wherein the PTC layer is formed of a polymeric PTC conductive composition.

13. The method of claim 12, wherein the polymeric PTC conductive composition comprises a polymer and a conductive filler.

14. The method of claim 13, wherein the polymer is a crystalline polymer selected from a group consisting of polypropylene, polyoctylene, polyvinylidene chloride, and mixtures thereof, or a semi-crystalline polymer such as polyvinylidene difluoride, polyethylene, ethylene tetrafluoroethylene, ethylene-vinyl acetate, ethylene butyl acrylate, and mixtures thereof.

15. The method of claim 13, wherein the conductive filler is selected from a group consisting of carbon black, metal powder, conductive ceramic powder, and mixtures thereof.

16. The method of claim 13, wherein the polymeric PTC conductive composition further comprises at least one of a photo initiator, a cross-link agent, a coupling agent, a dispersing agent, a stabilizer, an antioxidant, and a nonconductive anti-arcing filler.

17. The method of claim 11, wherein the first and second electrode are formed of one of copper, silver, tin, and gold.

18. The method of claim 11, wherein the first and second adhesive strips are formed of one of conductive glue and conductive epoxy.

19. The method of claim 11, wherein the first and second busbars are formed of an electrically conductive metal foil.

20. The method of claim 19, wherein the electrically conductive metal foil is formed of one of copper, gold, and silver.
